(19) United States
(12) Patent Application Publication
(10) Pub. No.: US 2025/0131300 A1
(43) Pub. Date: Apr. 24, 2025

(54) OPTIMIZING DEVELOPMENT OF A QUANTUM CIRCUIT OR A QUANTUM MODEL

(71) Applicant: International Business Machines Corporation, Armonk, NY (US)

(72) Inventors: John S. Werner, Fishkill, NY (US); Arkadiy O. Tsfasman, Wappingers Falls, NY (US); Vladimir Rastunkov, Mundelein, IL (US); Frederik Frank Flöther, Schlieren (CH)

(21) Appl. No.: 18/382,029

(22) Filed: Oct. 19, 2023

(51) Int. Cl. G06N 10/20

(52) U.S. Cl. CPC G06N 10/20

(57) ABSTRACT

A method, system, and computer program product for optimizing development of a quantum circuit or a quantum model on a development quantum system for later use on a production quantum system. Operational and performance data are obtained from the development quantum system and the production quantum system. A noise fingerprint for the development quantum system and a noise fingerprint for the production quantum system are then generated based on the obtained operational and performance data. A noise fingerprint refers to the main features of the quantum noise sources affecting a quantum device, such as a quantum system. Parameters of the development quantum system may then be continually adjusted until the difference between the noise fingerprint for the development quantum system and the noise fingerprint for the production quantum system is below a threshold value.

### TECHNICAL FIELD

The present disclosure relates generally to quantum computing, and more particularly to optimizing the development of a quantum circuit or a quantum model on a development quantum system for later use on a production quantum system.

### BACKGROUND

Quantum computing is a rapidly-emerging technology that harnesses the laws of quantum mechanics to solve problems too complex for classical computers. Quantum computing is a type of computation that harnesses the collective properties of quantum states, such as superposition, interference, and entanglement, to perform calculations. The devices that perform quantum computations are known as quantum computers. Though current quantum computers are generally not yet sufficiently mature enough to outperform usual (classical) computers for practical applications, they have the potential to solve certain computational problems, such as integer factorization, substantially faster than classical computers.

### SUMMARY

In one embodiment of the present disclosure, a method for optimizing development of a quantum circuit or a quantum model on a first quantum system for later use on a second quantum system comprises obtaining operational and performance data from the first and second quantum systems. The method further comprises generating a first noise fingerprint for the first quantum system and a second noise fingerprint for the second quantum system based on the obtained operational and performance data from the first and second quantum systems, respectively. The method additionally comprises adjusting parameters of the first quantum system until a difference between the first noise fingerprint of the first quantum system and the second noise fingerprint of the second quantum system is below a threshold value.

Other forms of the embodiment of the method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 illustrates an embodiment of the present disclosure of the hardware configuration of the room temperature electronics/service racks which is representative of a hardware environment for practicing the present disclosure;

FIG. 3 is a flowchart of a method for optimizing the development of a quantum circuit or a quantum model on the development quantum system for later use on the production quantum system by matching the noise fingerprint of the development quantum system to the noise fingerprint of the production quantum system in accordance with an embodiment of the present disclosure;

FIG. 4 is a flowchart of a method for adjusting the parameters of the development quantum system in order to match the noise fingerprint of the development quantum system with the noise fingerprint of the production quantum system in accordance with an embodiment of the present disclosure;

FIG. 5 is a quantum circuit diagram where the distance between the quantum states of the quantum circuit is measured in accordance with an embodiment of the present disclosure; and

FIGS. 6A-6C illustrate adjusting the parameters of the development quantum system over multiple iterations in accordance with an embodiment of the present disclosure.

### DETAILED DESCRIPTION

As stated above, quantum computing is a rapidly-emerging technology that harnesses the laws of quantum mechanics to solve problems too complex for classical computers. Quantum computing is a type of computation that harnesses the collective properties of quantum states, such as superposition, interference, and entanglement, to perform calculations. The devices that perform quantum computations are known as quantum computers. Though current quantum computers are generally not yet sufficiently mature enough to outperform usual (classical) computers for practical applications, they have the potential to solve certain computational problems, such as integer factorization, substantially faster than classical computers.

As the number of quantum devices and quantum data centers grows around the world, it is becoming more and more important to ensure compatibility and interoperability between the quantum hardware in different locations. Furthermore, it is important to ensure that the quantum circuits and quantum models that are developed on one quantum system (includes a quantum computer), such as the developer's quantum system, perform in a similar and predictable manner when executed on another quantum system. Due to the fact that different environments may be subject to different sources of noise, the quantum circuits and quantum models that are developed on one quantum system, such as the developer's quantum system, may not perform in a similar manner when executed on another quantum system, even if such quantum systems are compatible in terms of quantum hardware.

For example, it is common practice for developers to create quantum models and quantum circuits to meet the needs of their clients. However, due to the sensitivity of quantum systems, the performance of such quantum models and quantum circuits on the developer's quantum system can be different than the performance of the same quantum models and quantum circuits running on the client's quantum system that has a different noise fingerprint. A noise fingerprint refers to the main features of the quantum noise sources affecting a quantum device, such as a quantum system.

For instance, various sources can contribute to noise, such as temperature, humidity, vibration, location radiation (e.g., wireless communication frequencies), solar flares, etc. In another example, a quantum computer installed at one location (e.g., cafeteria) may experience different natural noise in comparison to another quantum computer installed at a different location (e.g., data center).

Unfortunately, there is not currently a means in ensuring that the quantum model and the quantum circuit developed on a developer's quantum system will perform in a similar manner when executed on a different quantum system, such as the client's quantum system (also referred to as the “production quantum system”).

The embodiments of the present disclosure provide the means for ensuring that the quantum model and the quantum circuit developed on a developer's quantum system will perform in a similar manner when executed on a different quantum system, such as the production quantum system. In one embodiment of the present disclosure, a noise fingerprint for the development quantum system (e.g., quantum system utilized by the developer) is compared with the noise fingerprint for the production quantum system (e.g., quantum system utilized by a client). A noise fingerprint, as used herein, refers to the main features of the quantum noise sources affecting a quantum device, such as a quantum system. When the difference between the noise fingerprints for the development and production quantum systems is not below a threshold value, then parameters of the development quantum system are continually adjusted until the difference between the noise fingerprints for the development and production quantum systems is below the threshold value. Various parameters of the development quantum system may be adjusted to tune the noise fingerprint of the development quantum system to the noise fingerprint of the production quantum system, such as pulse amplification, pulse attenuation, pulse modulation, pulse signal mixing, radio frequency radiated frequency, radio frequency transmit power, temperature setting of a quantum refrigerator, environmental temperature, environmental humidity, environmental pressure, vibration frequency, vibration amplitude, etc. In this manner, the quantum circuit and quantum model being developed on the developer's quantum system will perform in a similar manner when executed on the production quantum system. These and other features will be discussed in greater detail below.

In some embodiments of the present disclosure, the present disclosure comprises a method, system, and computer program product for optimizing development of a quantum circuit or a quantum model on a development quantum system for later use on a production quantum system. In one embodiment of the present disclosure, operational and performance data are obtained from the development quantum system and the production quantum system. Examples of such data can include, but are not limited to, historical and/or current calibration data, system settings, a quantum processor temperature, pulse settings, qubit coherence times, qubit errors, qubit and quantum gate fidelity, gate errors, T1 (thermal relation time) and T2 (dephasing time) times, performance history of quantum circuits, noise types, noise strength, etc. A noise fingerprint for the development quantum system and a noise fingerprint for the production quantum system are generated based on the obtained operational and performance data. A noise fingerprint, as used herein, refers to the main features of the quantum noise sources affecting a quantum device, such as a quantum system. In one embodiment, such noise fingerprints may correspond to eigenvectors which are generated based on the obtained operational and performance data. An eigenvector, as used herein, refers to a vector which, when operated on by a given operator, gives a scalar multiple of itself. Parameters of the development quantum system may then be continually adjusted until the difference between the noise fingerprint for the development quantum system and the noise fingerprint for the production quantum system is below a threshold value, which may be user-designated. Examples of such parameters to be adjusted on the development quantum system can include, but are not limited to, pulse amplification, pulse attenuation, pulse modulation, pulse signal mixing, radio frequency radiated frequency, radio frequency transmit power, temperature setting of a quantum refrigerator, environmental temperature, environmental humidity, environmental pressure, vibration frequency, vibration amplitude, etc. In this manner, the quantum circuit and the quantum model developed on a developer's quantum system will perform in a similar manner when executed on a different quantum system, such as the production quantum system.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

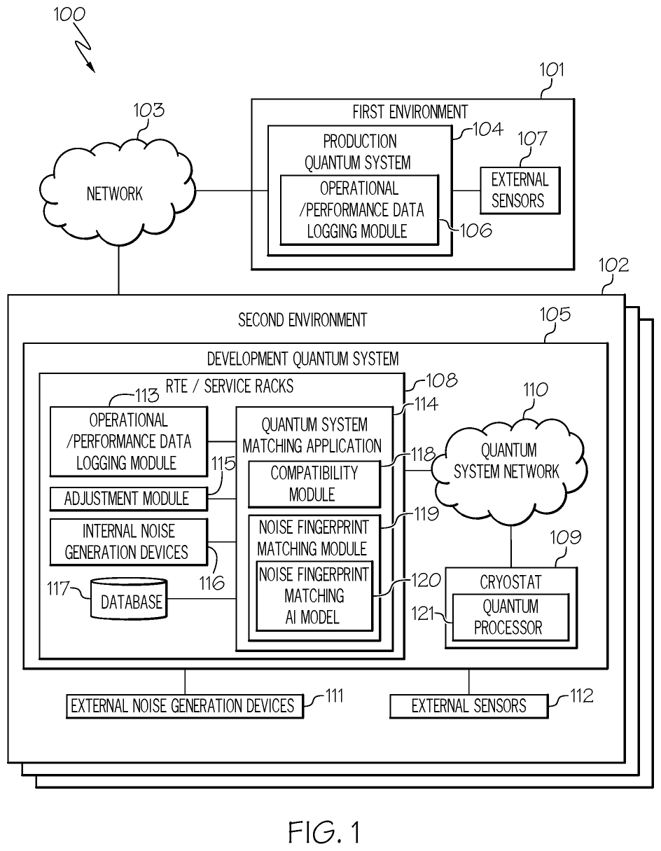

Referring now to the Figures in detail, FIG. 1 illustrates an embodiment of the present disclosure of a communication system 100 for practicing the principles of the present disclosure. Communication system 100 includes a first environment 101 connected to a second environment 102 via a network 103. An “environment,” as used herein, refers to a particular configuration of hardware or software. In one embodiment, the location of first and second environments 101, 102 is at a datacenter, in the cloud, or at a co-located datacenter (datacenter facility that rents out rack space to third parties for their servers or other network equipment).

In one embodiment, first environment 101 includes a production quantum system 104 and second environment 102 includes a development quantum system 105. Production quantum system 104 corresponds to the quantum system upon which the quantum circuit or quantum model being developed on development quantum system 105 is to be executed. In one embodiment, such quantum systems 104, 105 are connected to each other via network 103.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network and various combinations thereof. Other networks, whose descriptions are omitted here for brevity, may also be used in conjunction with system 100 of FIG. 1 without departing from the scope of the present disclosure.

In one embodiment, production quantum system 104 is not directly connected to development quantum system 105. Instead, a recorded performance (including its noise fingerprint) and/or noise fingerprint information from production quantum system 104 is imported into development quantum system 105.

Referring again to FIG. 1, production quantum system 104 includes an operation/performance data logging module 106 configured to record the events that occur in production quantum system 104. Such recorded events include data that assists in determining the noise fingerprint of production quantum system 104. A noise fingerprint, as used herein, refers to the main features of the quantum noise sources affecting a quantum device, such as a quantum system. Examples of such data can include, but are not limited to, historical and/or current calibration data, system settings, a quantum processor temperature, pulse settings, qubit coherence times, qubit errors, qubit and quantum gate fidelity, gate errors, T1 (thermal relation time) and T2 (dephasing time) times, performance history of quantum circuits, noise types, noise strength, etc.

In one embodiment, operation/performance data logging module 106 utilizes various software tools for performing such logging, which can include, but are not limited to, Splunk®, SolarWinds® Log Analyzer, ManageEngine® EventLog Analyzer, Datadog®, etc.

Furthermore, in one embodiment, first environment 101 optionally includes external sensors 107 connected to production quantum system 104. In one embodiment, external sensors 107 include any additional sensors that are not part of production quantum system 104 (e.g., vibration sensor, temperature sensor, humidity sensor, ambient radio frequency sensor, microphone, etc.) to monitor environmental surroundings that may impact the noise fingerprint of production quantum system 104.

As discussed above, the quantum circuit or quantum model is developed on development quantum system 105, such as by a developer. In one embodiment, development quantum system 105 includes room temperature electronics (RTE)/service racks 108 and a cryostat 109 (apparatus for maintaining a very low temperature) interconnected via a quantum system network 110. Quantum system network 110 may be any communication protocol that allows data to be transferred between components of the system (e.g., optical, peripheral component interconnect express (PCIe), I²C, Bluetooth, Wi-Fi, cellular (e.g., 3G, 4G, 5G), Ethernet, etc.)

In one embodiment, there are multiple development quantum systems 105 available to the developer which may be located in the same second environment 102 (e.g., located within the same datacenter) or located in different second environments 102 (e.g., located in different datacenters in different physical locations, such as being located in different buildings, different floors, different states, or different countries).

In one embodiment, second environment 102 is the location where development quantum system 105 is installed and also contains external noise generation devices 111 and optional external sensors 112.

In one embodiment, optional external sensors 112 include any additional sensors that are not part of development quantum system 105 (e.g., a vibration sensor, a temperature sensor, a humidity sensor, an ambient radio frequency sensor, a microphone, etc.) to monitor environmental surroundings that may impact the noise fingerprint of development quantum system 105.

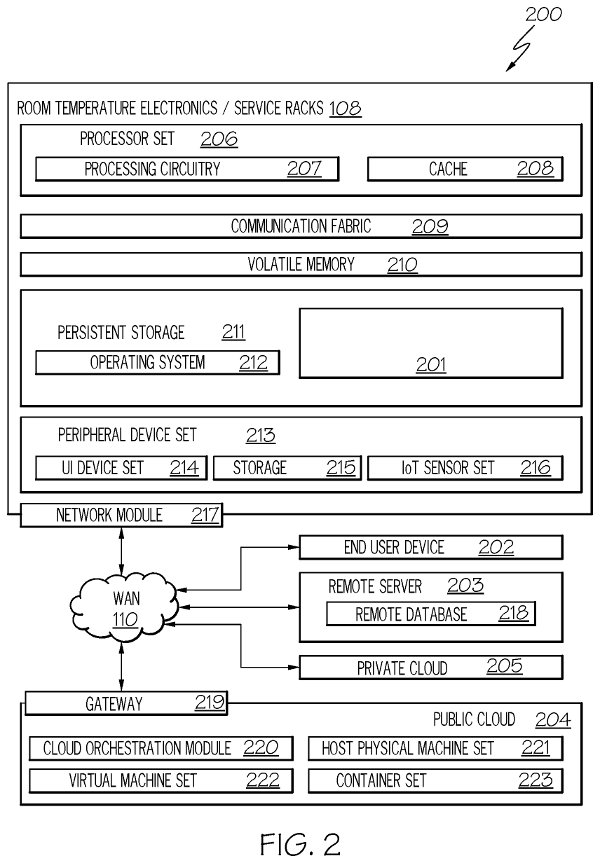

As discussed above, development quantum system 102 includes room temperature electronics (RTE)/service racks 108. In one embodiment, RTE/service racks 108 contains the classical computing components of development quantum system 105 and is comprised of operational/performance data logging module 113, quantum system matching application 114, adjustment module 115, internal noise generation devices 116, and database 117. A description of the hardware configuration of room temperature electronics/service racks 108 is provided further below in connection with FIG. 2.

In one embodiment, operational/performance data logging module 113 performs the same functionality as operational/performance data logging module 106 except that it captures data to help to determine a noise fingerprint of development quantum system 105.

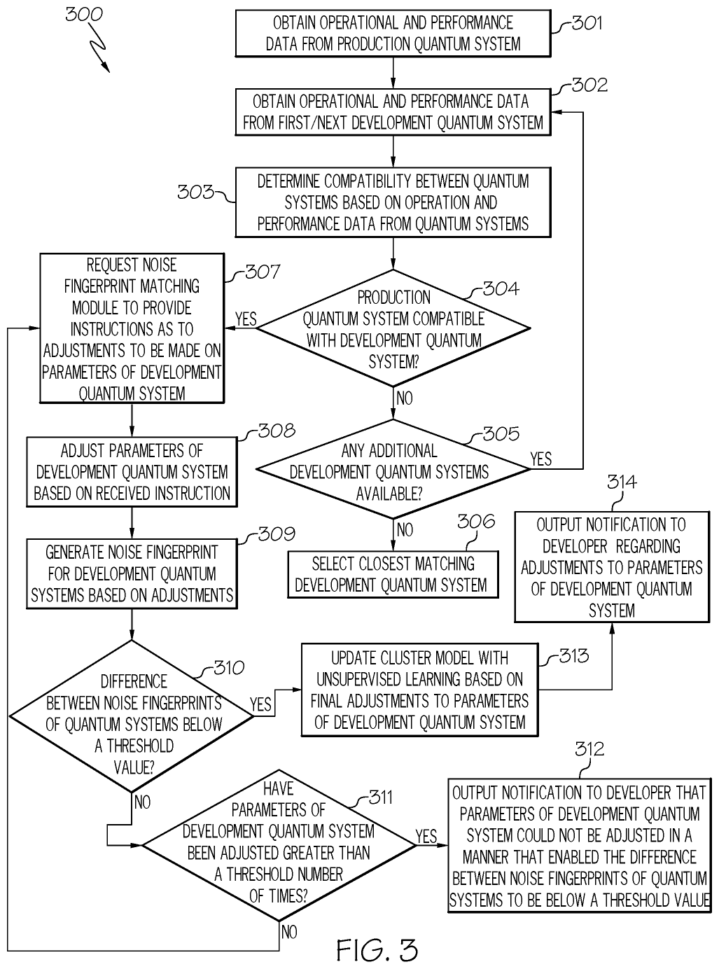

In one embodiment, quantum system matching application 114 is the program/application running on RTE/service racks 108 hardware that contains the modules required to perform the quantum system noise fingerprint matching for multi-system model development and is comprised of compatibility module 118 and noise fingerprint matching module 119. “Noise fingerprint matching,” as used herein, refers to the process as discussed herein of continually adjusting the parameters of development quantum system 105 until the difference between the noise fingerprints for development quantum system 105 and production quantum system 104 is below a threshold value, which may be user-designated. In one embodiment, such a threshold is not utilized and noise fingerprint matching module 119 implements the adjustments of the parameters of development quantum system 105 to make the difference between the noise fingerprints for development quantum system 105 and production quantum system 104 as small as possible. A further discussion regarding the noise fingerprint matching process implemented by quantum system matching application 114 is provided below in connection with FIG. 3.

In one embodiment, compatibility module 118 performs an analysis between production quantum system 104 and development quantum system 105 to determine whether development quantum system 105 can be considered for quantum system matching and used for development work. That is, compatibility module 118 determines whether the quantum circuits and/or quantum models being developed on development quantum system 105 can be used on production quantum system 104 due to system compatibility.

In one embodiment, compatibility module 118 determines such system compatibility by analyzing the number of qubits available, comparing coupling maps, qubit coherence times, qubit and gate fidelity, and using other information captured from operational/performance data logging module 106 and operational/performance data logging module 113 to compare the systems.

In one embodiment, the noise fingerprints for production and development quantum systems 104, 105 discussed above are represented by eigenvectors, which are created for each quantum system 104, 105. In one embodiment, such eigenvectors are created based on the operational and performance data captured from modules 106, 113. An eigenvector, as used herein, refers to a vector which, when operated on by a given operator, gives a scalar multiple of itself. In one embodiment, each parameter of the vector of the eigenvector indicates and scores a property of the quantum system, such as quantum system 104, 105.

In one embodiment, the functionality of development quantum system 105 is the same or better than production quantum system 104.

Furthermore, in one embodiment, compatibility module 118 determines whether the quantum circuits and/or quantum models being developed on development quantum system 105 can be used on production quantum system 104 due to system compatibility after adjustments are made to development quantum system 105. Additionally, in one embodiment, compatibility module 118 determines whether such adjustments were adequate to establish system compatibility.

Once compatibility is determined by compatibility module 118, noise fingerprint matching module 119 takes input from operational/performance data logging module 106 and operational/performance data logging module 113 to perform an analysis using noise fingerprint matching artificial intelligence (AI) model 120 which generates outputs for adjustments to the parameters of development quantum system 105 that can be made by adjustment module 115.

In one embodiment, such adjustments are made to the parameters of development quantum system 105 by adjustment module 115 to match the noise fingerprint of production quantum system 104 to the noise fingerprint of development quantum system 105. For example, adjustment module 115 may make the following adjustments to the parameters of development quantum system 105 in order to match the noise fingerprint of production quantum system 104 with the noise fingerprint of development quantum system 105. “Matching,” as used herein, refers to having the difference between the noise fingerprint of production quantum system 104 and the noise fingerprint of development quantum system 105 being below a threshold value, which may be user-designated. Examples of parameters of development quantum system 105 that may be adjusted by adjustment module 115 can include, but are not limited to, pulse amplification, pulse attenuation, pulse modulation, pulse signal mixing, radio frequency radiated frequency, radio frequency transmit power, temperature setting of a quantum refrigerator, environmental temperature, environmental humidity, environmental pressure, vibration frequency, vibration amplitude, etc.

In one embodiment, after each adjustment to the parameters of development quantum system 105 is made by adjustment module 115, noise fingerprint matching module 119 determines whether such adjustments caused the difference between the noise fingerprint of development quantum system 105 and the noise fingerprint of production quantum system 104 to be below a threshold value, which may be user-designated. As previously discussed, adjustment module 115 continues to implement such adjustments to the parameters of development quantum system 105 until the difference between the noise fingerprint of development quantum system 105 and the noise fingerprint of production quantum system 104 is below a threshold value, which may be user-designated. In this manner, due to the continuous adjustments to the parameters of development quantum system 105, the noise fingerprint of development quantum system 105 is tuned to match as closely as possible to the noise fingerprint of production quantum system 104. In this manner, the quantum circuits and quantum models developed on development quantum system 105 will be able to be performed in a similar manner when executed on production quantum system 104.

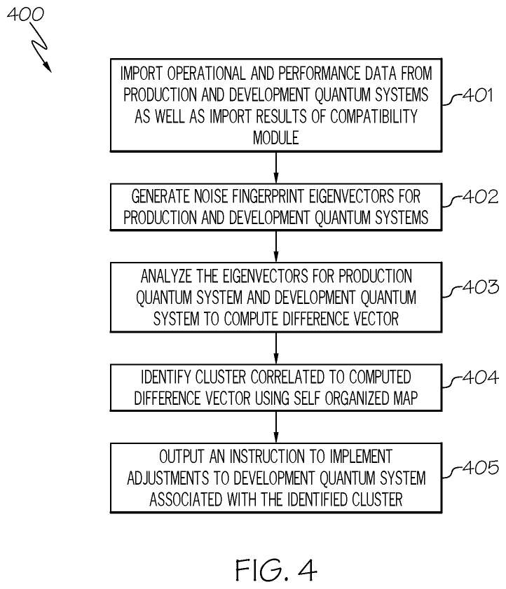

A further description of noise fingerprint matching module 119 is provided further below in connection with FIG. 4.

In one embodiment, noise fingerprint matching AI model 120 corresponds to a classical AI model that performs the comparison of quantum systems 104, 105 and generates outputs that can be sent to adjustment module 115.

In one embodiment, noise fingerprint matching AI model 120 uses eigenvectors to represent the noise fingerprints of quantum systems 104, 105. In one embodiment, noise fingerprint matching AI model 120 is configured to perform clustering on the difference between the two eigenvectors to obtain a set of adjustments that have worked in the past to match the noise fingerprint of development quantum system 105 with the noise fingerprint of production quantum system 104.

In one embodiment, multiple noise fingerprints of production quantum system 104 may be obtained (e.g., at different times of the day, different times of the year, etc.) such that different quantum models/quantum circuits can be developed, such as for a user of production quantum system 104, for different scenarios.

In one embodiment, if a quantum model/quantum circuit is planned to be deployed on multiple production quantum systems 104 in multiple locations, the parameters of the noise fingerprint of development quantum system 105 can be adjusted multiple times during a day, such as after each modification of the quantum circuit or quantum model being developed on development quantum system 105, so that the difference between the noise fingerprint of development quantum system 105 and the noise fingerprint of production quantum system 104 is below a threshold value. Alternatively, the noise fingerprint of development quantum system 105 is matched with the worst-case noise fingerprint amongst all production quantum systems 104 within a threshold degree of difference, which may be user-designated, or a noise fingerprint eigenvector is generated for development quantum system 105, where each parameter is the lowest score amongst all production quantum systems 104.

In one embodiment, noise fingerprints are calculated by noise fingerprint matching AI model 120 through stationary state techniques.

Further details regarding noise fingerprint matching AI model 120 are provided below in connection with FIG. 4.

In one embodiment, adjustment module 115 takes input from noise fingerprint matching AI model 120 and makes adjustments to the parameters of development quantum system 105 by sending control signals to internal noise generation devices 116 and/or external noise generation devices 111 such that development of quantum circuits/quantum models can be performed on development quantum system 105 and executed properly on production quantum system 104 since the difference between the noise fingerprints of development quantum system 105 and production quantum system 104 is below a threshold value, which may be user-designated. That is, adjustment module 115 takes input from noise fingerprint matching AI model 120 and makes adjustments to the parameters of development quantum system 105 by sending control signals to internal noise generation devices 116 and/or external noise generation devices 111 such that development of quantum circuits/quantum models can be performed on development quantum system 105 and executed properly on production quantum system 104 since the noise fingerprint of development quantum system 105 closely matches the noise fingerprint of production quantum system 104.

In one embodiment, such adjustments involve increasing noise on development quantum system 105. That is, adjustment module 115 introduces noise to development quantum system 105 in a controlled manor to focus on mimicking the noise of production quantum system 104.

By matching the noise fingerprint of development quantum system 105 to the noise fingerprint of production quantum system 104, there is a higher confidence level that performance of any quantum circuit/quantum model developed on development quantum system 105 will have similar performance when put into production, such as on production quantum system 104.

In one embodiment, internal noise generation devices 116 correspond to any device that can introduce conditions that will add noise that will impact the noise fingerprint of development quantum system 105. For example, such conditions can include, but are not limited to, changes to pulse settings, pulse level adjustments, signal attenuation, signal filtering, signal amplification, signal mixing, and/or temperature settings of the quantum refrigerator.

In one embodiment, database 117 contains data regarding the system characteristics, noise, benchmark information, calibration, operational history/performance, previous adjustments made and the resulting noise fingerprint which is used as training data for noise fingerprint matching AI model 120, etc.

In one embodiment, cryostat 109 cools quantum processor 121 of development quantum system 105 and is one of the components to which adjustments could be made for noise fingerprint matching.

In one embodiment, quantum processor 121 executes the quantum circuits/quantum models where development is performed.

In one embodiment, quantum processor 121 differs from the quantum processor of production quantum system 104 in terms of the number of qubits, coherence times, qubit and gate fidelity, etc. which could lead to differing performance between the two systems if adjustments are not performed.

In one embodiment, external noise generation devices 111 are any devices that can introduce conditions that will add noise that will impact the noise fingerprint of quantum development system 105.

External noise generation devices 111 can include, but are not limited to, vibration generation devices, radio frequency (RF) antennas (to introduce noise at different radiated power levels and different frequencies to either match pulse frequencies or match frequencies observed within first environment 101), environmental controls (temperature and humidity within second environment 102), etc.

Referring now to FIG. 2, in conjunction with FIG. 1, FIG. 2 illustrates an embodiment of the present disclosure of the hardware configuration of room temperature electronics/service racks 108 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 200, which in one embodiment corresponds to second environment 102, contains an example of an environment for the execution of at least some of the computer code (stored in block 201) involved in performing the inventive methods, such as optimizing the development of a quantum circuit or a quantum model on the development quantum system for later use on the production quantum system by matching the noise fingerprint of the production quantum system to the noise fingerprint of the development quantum system. In addition to block 201, computing environment 200 includes, for example, room temperature electronics/service racks 108, network 110, such as a wide area network (WAN), end user device (EUD) 202, remote server 203, public cloud 204, and private cloud 205. In this embodiment, room temperature electronics/service racks 108 includes processor set 206 (including processing circuitry 207 and cache 208), communication fabric 209, volatile memory 210, persistent storage 211 (including operating system 212 and block 201, as identified above), peripheral device set 213 (including user interface (UI) device set 214, storage 215, and Internet of Things (IoT) sensor set 216), and network module 217. Remote server 203 includes remote database 218. Public cloud 204 includes gateway 219, cloud orchestration module 220, host physical machine set 221, virtual machine set 222, and container set 223.

Room temperature electronics/service racks 108 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 218. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically room temperature electronics/service racks 108, to keep the presentation as simple as possible. Room temperature electronics/service racks 108 may be located in a cloud, even though it is not shown in a cloud in FIG. 2. On the other hand, room temperature electronics/service racks 108 is not required to be in a cloud except to any extent as may be affirmatively indicated.

Processor set 206 includes one, or more, computer processors of any type now known or to be developed in the future. Processing circuitry 207 may be distributed over multiple packages, for example, multiple, coordinated integrated circuit chips. Processing circuitry 207 may implement multiple processor threads and/or multiple processor cores. Cache 208 is memory that is located in the processor chip package(s) and is typically used for data or code that should be available for rapid access by the threads or cores running on processor set 206. Cache memories are typically organized into multiple levels depending upon relative proximity to the processing circuitry. Alternatively, some, or all, of the cache for the processor set may be located “off chip.” In some computing environments, processor set 206 may be designed for working with qubits and performing quantum computing.

Computer readable program instructions are typically loaded onto room temperature electronics/service racks 108 to cause a series of operational steps to be performed by processor set 206 of room temperature electronics/service racks 108 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 208 and the other storage media discussed below. The program instructions, and associated data, are accessed by processor set 206 to control and direct performance of the inventive methods. In computing environment 200, at least some of the instructions for performing the inventive methods may be stored in block 201 in persistent storage 211.

Communication fabric 209 is the signal conduction paths that allow the various components of room temperature electronics/service racks 108 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 210 is any type of volatile memory now known or to be developed in the future. Examples include dynamic type random access memory (RAM) or static type RAM. Typically, the volatile memory is characterized by random access, but this is not required unless affirmatively indicated. In room temperature electronics/service racks 108, the volatile memory 210 is located in a single package and is internal to room temperature electronics/service racks 108, but, alternatively or additionally, the volatile memory may be distributed over multiple packages and/or located externally with respect to room temperature electronics/service racks 108.

Persistent Storage 211 is any form of non-volatile storage for computers that is now known or to be developed in the future. The non-volatility of this storage means that the stored data is maintained regardless of whether power is being supplied to room temperature electronics/service racks 108 and/or directly to persistent storage 211. Persistent storage 211 may be a read only memory (ROM), but typically at least a portion of the persistent storage allows writing of data, deletion of data and re-writing of data. Some familiar forms of persistent storage include magnetic disks and solid state storage devices. Operating system 212 may take several forms, such as various known proprietary operating systems or open source Portable Operating System Interface type operating systems that employ a kernel. The code included in block 201 typically includes at least some of the computer code involved in performing the inventive methods.

Peripheral device set 213 includes the set of peripheral devices of room temperature electronics/service racks 108. Data communication connections between the peripheral devices and the other components of room temperature electronics/service racks 108 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 214 may include components such as a display screen, speaker, microphone, wearable devices (such as goggles and smart watches), keyboard, mouse, printer, touchpad, game controllers, and haptic devices. Storage 215 is external storage, such as an external hard drive, or insertable storage, such as an SD card. Storage 215 may be persistent and/or volatile. In some embodiments, storage 215 may take the form of a quantum computing storage device for storing data in the form of qubits. In embodiments where room temperature electronics/service racks 108 is required to have a large amount of storage (for example, where room temperature electronics/service racks 108 locally stores and manages a large database) then this storage may be provided by peripheral storage devices designed for storing very large amounts of data, such as a storage area network (SAN) that is shared by multiple, geographically distributed computers. IoT sensor set 216 is made up of sensors that can be used in Internet of Things applications. For example, one sensor may be a thermometer and another sensor may be a motion detector.

Network module 217 is the collection of computer software, hardware, and firmware that allows room temperature electronics/service racks 108 to communicate with other computers through WAN 110. Network module 217 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 217 are performed on the same physical hardware device. In other embodiments (for example, embodiments that utilize software-defined networking (SDN)), the control functions and the forwarding functions of network module 217 are performed on physically separate devices, such that the control functions manage several different network hardware devices. Computer readable program instructions for performing the inventive methods can typically be downloaded to room temperature electronics/service racks 108 from an external computer or external storage device through a network adapter card or network interface included in network module 217.

WAN 110 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 202 is any computer system that is used and controlled by an end user (for example, a customer of an enterprise that operates room temperature electronics/service racks 108), and may take any of the forms discussed above in connection with room temperature electronics/service racks 108. EUD 202 typically receives helpful and useful data from the operations of room temperature electronics/service racks 108. For example, in a hypothetical case where room temperature electronics/service racks 108 is designed to provide a recommendation to an end user, this recommendation would typically be communicated from network module 217 of room temperature electronics/service racks 108 through WAN 110 to EUD 202. In this way, EUD 202 can display, or otherwise present, the recommendation to an end user. In some embodiments, EUD 202 may be a client device, such as thin client, heavy client, mainframe computer, desktop computer and so on.

Remote server 203 is any computer system that serves at least some data and/or functionality to room temperature electronics/service racks 108. Remote server 203 may be controlled and used by the same entity that operates room temperature electronics/service racks 108. Remote server 203 represents the machine(s) that collect and store helpful and useful data for use by other computers, such as room temperature electronics/service racks 108. For example, in a hypothetical case where room temperature electronics/service racks 108 is designed and programmed to provide a recommendation based on historical data, then this historical data may be provided to room temperature electronics/service racks 108 from remote database 218 of remote server 203.

Public cloud 204 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 204 is performed by the computer hardware and/or software of cloud orchestration module 220. The computing resources provided by public cloud 204 are typically implemented by virtual computing environments that run on various computers making up the computers of host physical machine set 221, which is the universe of physical computers in and/or available to public cloud 204. The virtual computing environments (VCEs) typically take the form of virtual machines from virtual machine set 222 and/or containers from container set 223. It is understood that these VCEs may be stored as images and may be transferred among and between the various physical machine hosts, either as images or after instantiation of the VCE. Cloud orchestration module 220 manages the transfer and storage of images, deploys new instantiations of VCEs and manages active instantiations of VCE deployments. Gateway 219 is the collection of computer software, hardware, and firmware that allows public cloud 204 to communicate through WAN 110.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 205 is similar to public cloud 204, except that the computing resources are only available for use by a single enterprise. While private cloud 205 is depicted as being in communication with WAN 110 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 204 and private cloud 205 are both part of a larger hybrid cloud.

Block 201 further includes the software components (e.g., compatibility module 118, noise fingerprint matching module 119, etc.) discussed above in connection with FIG. 1 to optimize development of a quantum circuit or a quantum model on the development quantum system for later use on the production quantum system by matching the noise fingerprint of the production quantum system to the noise fingerprint of the development quantum system. In one embodiment, such components may be implemented in hardware. The functions discussed above performed by such components are not generic computer functions. As a result, room temperature electronics/service racks 108 is a particular machine that is the result of implementing specific, non-generic computer functions.

In one embodiment, the functionality of such software components of room temperature electronics/service racks 108, including the functionality for optimizing the development of a quantum circuit or a quantum model on the development quantum system for later use on the production quantum system by matching the noise fingerprint of the production quantum system to the noise fingerprint of the development quantum system, may be embodied in an application specific integrated circuit.

As stated above, as the number of quantum devices and quantum data centers grows around the world, it is becoming more and more important to ensure compatibility and interoperability between the quantum hardware in different locations. Furthermore, it is important to ensure that the quantum circuits and quantum models that are developed on one quantum system (includes a quantum computer), such as the developer's quantum system, perform in a similar and predictable manner when executed on another quantum system. Due to the fact that different environments may be subject to different sources of noise, the quantum circuits and quantum models that are developed on one quantum system, such as the developer's quantum system, may not perform in a similar manner when executed on another quantum system, even if such quantum systems are compatible in terms of quantum hardware. For example, it is common practice for developers to create quantum models and quantum circuits to meet the needs of their clients. However, due to the sensitivity of quantum systems, the performance of such quantum models and quantum circuits on the developer's quantum system can be different than the performance of the same quantum models and quantum circuits running on the client's quantum system that has a different noise fingerprint. A noise fingerprint refers to the main features of the quantum noise sources affecting a quantum device, such as a quantum system. For instance, various sources can contribute to noise, such as temperature, humidity, vibration, location radiation (e.g., wireless communication frequencies), solar flares, etc. In another example, a quantum computer installed at one location (e.g., cafeteria) may experience different natural noise in comparison to another quantum computer installed at a different location (e.g., data center). Unfortunately, there is not currently a means in ensuring that the quantum model and the quantum circuit developed on a developer's quantum system will perform in a similar manner when executed on a different quantum system, such as the client's quantum system (also referred to as the “production quantum system”).

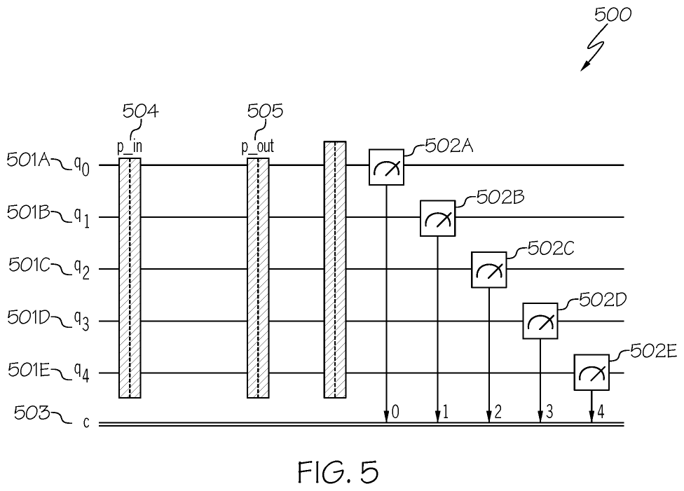

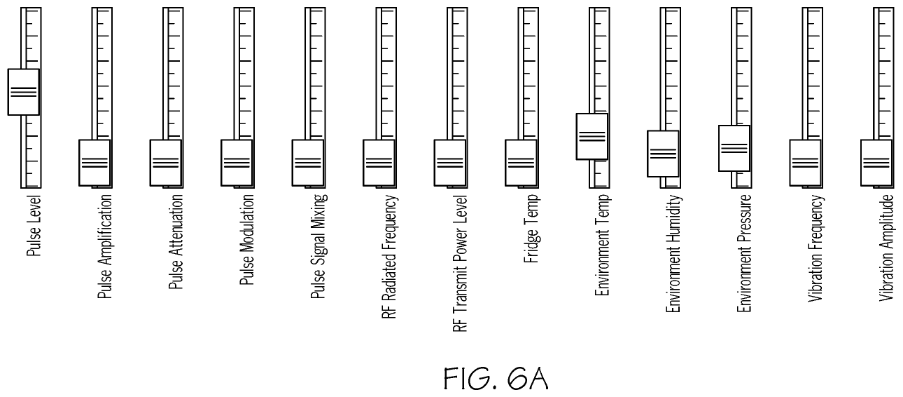

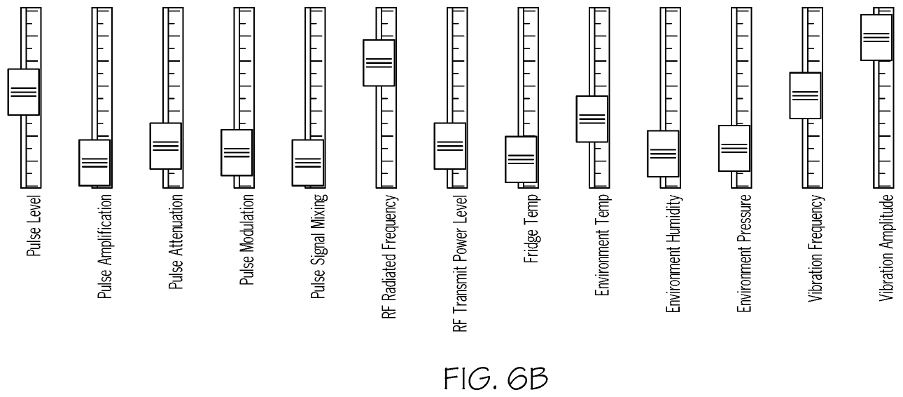

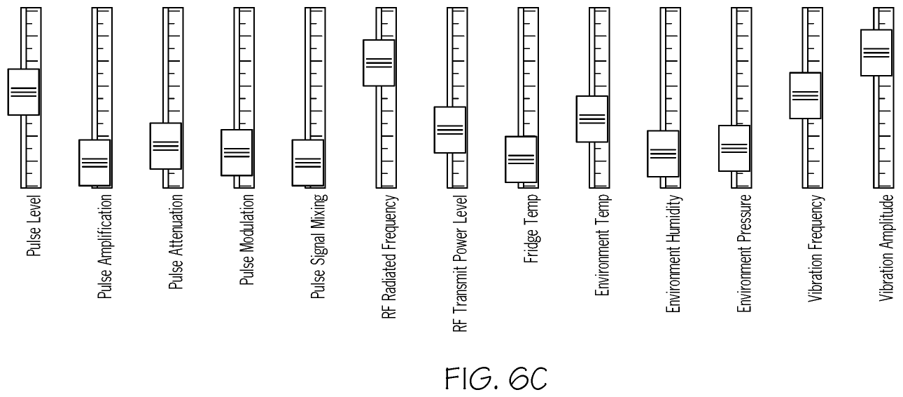

The embodiments of the present disclosure provide the means for ensuring that the quantum model and the quantum circuit developed on a developer's quantum system will perform in a similar manner when executed on a different quantum system, such as the production quantum system, as discussed below in connection with FIGS. 3-5 and 6A-6C. FIG. 3 is a flowchart of a method for optimizing the development of a quantum circuit or a quantum model on the development quantum system (e.g., development quantum system 105) for later use on the production quantum system (e.g., production quantum system 104) by matching the noise fingerprint of the development quantum system to the noise fingerprint of the production quantum system. FIG. 4 is a flowchart of a method for adjusting the parameters of the development quantum system (e.g., development quantum system 105) in order to match the noise fingerprint of the development quantum system with the noise fingerprint of the production quantum system. FIG. 5 is a quantum circuit diagram where the distance between the quantum states of the quantum circuit is measured. FIGS. 6A-6C illustrate adjusting the parameters of the development quantum system (e.g., development quantum system 105) over multiple iterations.

As stated above, FIG. 3 is a flowchart of a method 300 for optimizing the development of a quantum circuit or a quantum model on the development quantum system (e.g., development quantum system 105) for later use on the production quantum system (e.g., production quantum system 104) by matching the noise fingerprint of the production quantum system to the noise fingerprint of the development quantum system in accordance with an embodiment of the present disclosure.

Referring to FIG. 3, in conjunction with FIGS. 1-2, in step 301, operational/performance data logging module 106 obtains the operational and performance data from production quantum system 104.

As discussed above, operation/performance data logging module 106 is configured to record the events that occur in production quantum system 104. Such recorded events include data that assists in determining the noise fingerprint of production quantum system 104. Examples of such data can include, but are not limited to, historical and/or current calibration data, system settings, a quantum processor temperature, pulse settings, qubit coherence times, qubit errors, qubit and quantum gate fidelity, gate errors, T1 (thermal relation time) and T2 (dephasing time) times, performance history of quantum circuits, noise types, noise strength, etc.

In one embodiment, operation/performance data logging module 106 utilizes various software tools for performing such logging, which can include, but are not limited to, Splunk®, SolarWinds® Log Analyzer, ManageEngine® EventLog Analyzer, Datadog®, etc.

In step 302, operational/performance data logging module 113 obtains the operational and performance data from a development quantum system 105.

As stated above, in one embodiment, operational/performance data logging module 113 performs the same functionality as operational/performance data logging module 106 except that it captures data to help to determine a noise fingerprint of development quantum system 105.

In step 303, compatibility module 118 determines compatibility between production quantum system 104 and development quantum system 105 based on the operation and performance data from quantum systems 104, 105 (obtained in steps 301, 302).

As discussed above, in one embodiment, compatibility module 118 performs an analysis between production quantum system 104 and development quantum system 105 to determine whether development quantum system 105 can be considered for quantum system matching and used for development work. That is, compatibility module 118 determines whether the quantum circuits and/or quantum models being developed on development quantum system 105 can be used on production quantum system 104 due to system compatibility.

In one embodiment, compatibility module 118 determines such system compatibility by analyzing the number of qubits available, comparing coupling maps, qubit coherence times, qubit and gate fidelity, and using other information captured from operational/performance data logging module 106 and operational/performance data logging module 113 to compare the systems.

In one embodiment, compatibility module 118 determines compatibility between production quantum system 104 and development quantum system 105 based on the operational and performance data from production quantum system 104 and development quantum system 105, where such systems 104, 105 are deemed to be compatible if at least a portion of a coupling map of development quantum system 105 is within a threshold degree of similarity to at least a portion of a coupling map of production quantum system 104 or if the qubit coherence time and the gate fidelity on matching portions of the coupling maps of quantum systems 104, 105 are the same or better on development quantum system 105 than production quantum system 104.

In one embodiment, such systems are deemed to be compatible if the similarity between such operation and performance data from quantum systems 104, 105 are within a threshold degree of similarity.

In one embodiment, such similarity between the operation and performance data from quantum systems 104, 105 may be determined by vectorizing the operation and performance data, such as via Word2vec, Doc2Vec, GloVe, etc. After being converted into real-valued vectors, a similarity measure, such as cosine similarity, Euclidean distance, or Minkowski distance, may be used to determine the similarity between the operation and performance data of quantum systems 104, 105. Such a similarity measure is compared to a threshold value, which may be user-designated, to determine if the operation and performance data are within a threshold degree of similarity to one another. If the similarity measure does not exceed such a threshold value, then the operation and performance data of quantum systems 104, 105 are deemed to be within a threshold degree of similarity. As a result, such systems 104, 105 are deemed to be compatible. Otherwise, the operation and performance data of quantum systems 104, 105 are not deemed to be within the threshold degree of similarity. As a result, such systems 104, 105 are deemed to not be compatible.

“Cosine similarity,” as used herein, refers to a measure of similarity between two non-zero vectors defined in an inner product space. Cosine similarity is the cosine of the angle between the vectors. That is, it is the dot product of the vectors divided by the product of their lengths. If the measurement does not exceed a threshold value, which may be user-designated, then the operation and performance data of quantum systems 104, 105 are deemed to be within a threshold degree of similarity. Otherwise, the operation and performance data of quantum systems 104, 105 are not deemed to be within the threshold degree of similarity.

In one embodiment, the Euclidean distance is calculated as the square root of the sum of the squared differences between the two feature vectors. If the distance does not exceed a threshold value (i.e., there is a small distance between vectors), which may be user-designated, then the operation and performance data of quantum systems 104, 105 are deemed to be within a threshold degree of similarity. Otherwise, the operation and performance data of quantum systems 104, 105 are not deemed to be within the threshold degree of similarity.

In one embodiment, the Minkowski distance is a distance measured between two points in N-dimensional space. If the distance does not exceed a threshold value, which may be user-designated, then the operation and performance data of quantum systems 104, 105 are deemed to be within a threshold degree of similarity. Otherwise, the operation and performance data of quantum systems 104, 105 are not deemed to be within the threshold degree of similarity.

In one embodiment, the similarity measure is a score between the values of 0 and 1 for vectors that have only positive values. In one embodiment, any negative scores can be made positive by taking its absolute value.

In one embodiment, certain quantum system parameters are mandatory to indicate compatibility.

In one embodiment, such compatibility between quantum systems 104, 105 may be based on a matching subsection of the coupling maps of quantum systems 104, 105. A coupling map, as used herein, refers to a topology diagram that indicates the pairs of qubits that support two-qubit gate operations between them.

Compatibility module 118 utilizes various software tools for generating the similarity score, which can include, but are not limited to, TensorFlow®, Math Works®, plus sklearn, scikit-Learn®, etc.

In step 304, compatibility module 118 determines whether production quantum system 104 is compatible with development quantum system 105.

If such systems are not compatible, then, in step 305, compatibility module 118 determines whether there are additional development quantum systems 105 available for comparison with production quantum system 104.

If there are additional development quantum systems 105 to be compared with production quantum system 104, then operational/performance data logging module 113 obtains the operational and performance data from the next development quantum system 105 in step 302.

If, however, there are no additional development quantum systems 105 available for comparison with production quantum system 104, then, in step 306, compatibility module 118 selects the closest matching development quantum system 105. In such a scenario, production quantum system 104 has better operation and performance capability than development quantum system 105. As a result, development of the quantum circuit or quantum model proceeds in the same manner as currently performed.

If, however, production quantum system 104 and development quantum system 105 are deemed to be compatible, then, in step 307, adjustment module 115 requests noise fingerprint matching module 119 to provide instructions as to adjustments to be made on the parameters of development quantum system 105 to tune the noise fingerprint of development quantum system 105 to match the noise fingerprint of production quantum system 104.

A discussion regarding noise fingerprint matching module 119/noise fingerprint matching AI model 120 generating such noise fingerprints for product and development quantum systems 104, 105 and issuing instructions to adjust the parameters of development quantum system 105 to tune the noise fingerprint of development quantum system 105 to match the noise fingerprint of production quantum system 104 is provided below in connection with FIG. 4.

FIG. 4 is a flowchart of a method 400 for adjusting the parameters of the development quantum system (e.g., development quantum system 105) to match the noise fingerprint of the development quantum system with the noise fingerprint of the production quantum system (e.g., production quantum system 104) in accordance with an embodiment of the present disclosure.

Referring to FIG. 4, in conjunction with FIGS. 1-3, in step 401, noise fingerprint matching module 119 imports the operational and performance data from production quantum system 104 and development quantum system 105 from modules 106, 113, respectively. Furthermore, in one embodiment, noise fingerprint matching module 119 further imports the results of compatibility module 118. That is, noise fingerprint matching module 119 further imports the results in determining the compatibility between production quantum system 104 and development quantum system 105 based on the operation and performance data from quantum systems 104, 105 (obtained in steps 301, 302).

In step 402, noise fingerprint matching AI model 120 generates noise fingerprint eigenvectors for production and development quantum systems 104, 105. In one embodiment, such eigenvectors are created based on the operational and performance data captured from modules 106, 113. An eigenvector, as used herein, refers to a vector which, when operated on by a given operator, gives a scalar multiple of itself. In one embodiment, each parameter of the vector of the eigenvector indicates and scores a property of the quantum system, such as quantum system 104, 105.

In one embodiment, the operation and performance data captured from modules 106, 113 are converted into matrices. An eigenvector of a matrix is a characteristic vector on which a linear transformation behaves like a scalar multiplication by a constant named eigenvalue. Noise fingerprint matching AI model 120 may then determine the noise fingerprint eigenvectors from such a matrix using various software tools, which can include, but are not limited to, Eigenvectors Tutor from Maplesoft®, Matlab®, wxMaxima, etc.

In one embodiment, the eigenvector is a multiparameter vector that can include direct information, such as noise characteristics, or indirect information, such as historical metadata and execution results as well as device characteristics from which the environmental impact can be inferred.

In one embodiment, the eigenvector contains information including, but not limited to, system settings, quantum processor temperature, pulse settings between RTE/service racks 108 and cryostat 109, filter settings, amplification settings, attenuation settings, vibration settings, radio frequency settings, qubit coherence times, qubit errors, qubit and quantum gate fidelity, gate errors, T1 (thermal relation time) and T2 (dephasing time) times, performance history of quantum circuits, noise types, and noise strengths.

In one embodiment, for development quantum system 105, additional tests are conducted to obtain a better understanding of the current eigenvector prior to developing quantum circuits/quantum models on development quantum system 105 by running test calculations, such as stationary state calculations.

In one embodiment, the noise fingerprint for development quantum system 105 is the noise fingerprint only in the sub-coupling map region that matches production quantum system 104 where compatibility was determined.

In one embodiment, the noise fingerprint is in the form of a frequency spectrum instead of using eigenvectors.

In step 403, noise fingerprint matching AI model 120 analyzes the eigenvectors for production quantum system 104 and development quantum system 105 to compute the difference vector. The “difference vector,” as used herein, refers to the difference between the eigenvectors for production quantum system 104 and development quantum system 105.

In one embodiment, the difference vector is computed by determining the difference in the similarity between the eigenvectors of production quantum system 104 and development quantum system 105, such as by computing the cosine similarity, Euclidean distance, or Minkowski distance.

“Cosine similarity,” as used herein, refers to a measure of similarity between two non-zero vectors defined in an inner product space. Cosine similarity is the cosine of the angle between the vectors. That is, it is the dot product of the vectors divided by the product of their lengths. In one embodiment, the Euclidean distance is calculated as the square root of the sum of the squared differences between the two feature vectors. In one embodiment, the Minkowski distance is a distance measured between two points in N-dimensional space.

In one embodiment, noise fingerprint matching AI model 120 utilizes various software tools for computing the difference vector, which can include, but are not limited to, TensorFlow®, MathWorks®, plus sklearn, scikit-Learn®, etc.

In one embodiment, the difference vector is the same dimensionality as the eigenvectors containing the difference between each parameter of the compared eigenvectors.

In one embodiment, one or more metrics can be defined to be weighted higher in the eigenvector, such as accuracy, AUC (area under the ROC curve), precision, recall, robustness to different types of noise, fairness, etc.

In one embodiment, the eigenvectors represent the possible quantum states of quantum systems 104, 105. As a result, in one embodiment, the difference vector is calculated based on the distance between quantum states ρ_out produced by the quantum circuit as illustrated in FIG. 5 as follows:

$$D ( ρ , σ ) ≡ \frac{1}{2} t r \vert ρ - σ \vert = \frac{1}{2} t r \sqrt{{( ρ - σ )}^{†} ( ρ - σ )} \qquad ( 1 )$$

$$F ( ρ , σ ) ≡ t r \sqrt{{ρ}^{1 / 2} σ {ρ}^{1 / 2}} ( fidelity ) \qquad ( 2 )$$

where σ, ρ are density matrices of the final states on two systems, such as quantum systems 104, 105.

FIG. 5 is a quantum circuit diagram where the distance between the quantum states of the quantum circuit is measured in accordance with an embodiment of the present disclosure.

Referring to FIG. 5, quantum circuit diagram 500 illustrates a quantum circuit utilizing 5 qubits (qubit 0 (q₀), qubit 1 (q₁), qubit 2 (q₂), qubit 3 (q₃), and qubit 4 (q₄)) which are represented by horizontal lines 501A-501E, respectively.

Furthermore, quantum circuit diagram 500 illustrates measurement gates 502A-502E measuring qubits q₀, q₁, q₂, q₃, and q₄, respectively. Additionally, quantum circuit diagram 500 illustrates reading the measurements of the qubits from horizontal line 503 represented by “c.”

Furthermore, quantum circuit diagram 500 illustrates the density matrix p, including the input states (ρ_in) 504 and the output states (ρ_out) 505, where the distance between states ρ_out produced by the quantum circuit of FIG. 5 is calculated using formulas (1) and (2).

Returning to FIG. 4, in conjunction with FIGS. 1-3 and 5, in one embodiment, the distance between the quantum states to obtain the difference vector is calculated using classical shadows.

In one embodiment, the distance between the quantum states measured on the quantum circuit as shown in FIG. 5 to obtain the difference vector is calculated as the Chi-square or Kolmogorov-Smirnov statistic between two distributions of bitstrings.

In step 404, noise fingerprint matching AI model 120 identifies the cluster correlated to the computed difference vector using a self organized map.

A self organized map, as used herein, refers to an unsupervised machine learning technique used to produce a low-dimension (typically two-dimensional) representation of a higher dimensional data set while preserving the topological structure of the data. For example, a data set with p variables measured in n observations could be represented as clusters of observations with similar values for the variables. These clusters are then visualized as a two-dimensional “map” such that observations in proximal clusters have more similar values than observations in distal clusters.

In one embodiment, such clusters in the self organizing map are associated with a particular adjustment to be made in development quantum system 105, such as a particular adjustment to a particular parameter of development quantum system 105. In one embodiment, each cluster is identified by a unique difference vector. As a result, upon computing the difference vector in step 403, such a difference vector is used to identify a specific cluster in the self organized map which is used to identify a specific adjustment to be made in development quantum system 105, such as a particular adjustment to a particular parameter of development quantum system 105.

In one embodiment, such clusters of the self organized map are correlated to difference vectors using k-means, Gaussian mixture model clustering, or principal component analysis (PCA).

In one embodiment, each development quantum system 105 contains its own cluster model.

In one embodiment, clustering is performed across many development quantum systems 105 to create a larger dataset.

In one embodiment, an initial training dataset is created working backwards with supervised training by introducing noise and/or adjusting settings of development quantum system 105 and recording the difference vector that resulted between the before and after states.

In step 405, noise fingerprint matching module 119 outputs an instruction, such as to adjustment module 115, to implement adjustments to development quantum system 105 associated with the identified cluster.

In one embodiment, each cluster is associated with a collection of one or more setting adjustments for development quantum system 105 that were used in the past to match the noise fingerprint of production quantum system 104. Upon identifying a cluster correlated to the computed difference vector, the collection of setting adjustments for development quantum system 105 associated with the identified cluster is outputted via an instruction to perform such adjustments. For example, the collection of setting adjustments may include increasing vibration frequency to 432 Hz and lowering environmental pressure to 0.6 Pa.

Returning now to FIG. 3, in conjunction with FIGS. 1-2 and 4-5, in step 308, adjustment module 115 adjusts the parameters of development quantum system 105 based on the instruction received from noise fingerprint matching module 119. For example, the instruction received from noise fingerprint matching module 119 may include an instruction to adjust the parameters of development quantum system 105, such as increasing the vibration frequency to 432 Hz and lowering environmental pressure to 0.6 Pa. Adjustment module 115 then implements such adjustments either directly or indirectly, such as instructing an ultrasonic sensor to increase the vibration frequency to 432 Hz and instructing a pressure differential sensor to adjust the environmental pressure to 0.6 Pa. Such sensors may correspond to internal noise generation devices 116, external noise generation devices 111, and/or external sensors 112.

In one embodiment, such adjustments increase or decrease the noise on development quantum system 105 so that the noise fingerprint closely matches the noise fingerprint of production quantum system 104.

In one embodiment, adjustment module 115 adjusts the parameters of development quantum system 105 based on the instruction received from noise fingerprint matching module 119 by introducing noise to development quantum system 105, such as by controlling internal noise generation devices 116 and/or external noise generation devices 111. Examples of parameter adjustments performed by adjustment module 115 on development quantum system 105 can include, but are not limited to, pulse settings, pulse level adjustments, signal attenuation, signal filtering, signal amplification, signal mixing, temperature settings of the quantum refrigerator, vibration generation devices, radio frequency (RF) antennas (to introduce noise at different radiated power levels and different frequencies to either match pulse frequencies or match frequencies observed within first environment 101), environmental controls (temperature and humidity within second environment 102), etc.

In step 309, noise fingerprint matching AI model 120 generates the noise fingerprint, such as represented by an eigenvector, for development quantum system 105 after adjustment of the parameters of development quantum system 105.

In one embodiment, operational and performance data of development quantum system 105 are obtained from operational/performance data logging module 113 after adjustment of the parameters of development quantum system 105. In one embodiment, such a noise fingerprint corresponds to an eigenvector which is created based on the operational and performance data captured from module 113 as discussed above. In one embodiment, a delay may be implemented between steps 308 and 309 to ensure that development quantum system 105 has had time to adjust to the new parameters.

In one embodiment, a test routine is performed after adjustments are made to determine the impact on the noise fingerprint.

In step 310, noise fingerprint matching module 119 determines whether the difference between the noise fingerprint of development quantum system 105 after adjustment of the parameters of development quantum system 105 and the noise fingerprint of production quantum system 104 is below a threshold value, which may be user-designated. That is, noise fingerprint matching module 119 determines whether the difference between the noise fingerprint eigenvector of development quantum system 105 after adjustment of the parameters of development quantum system 105 and the noise fingerprint eigenvector of production quantum system 104 is below a threshold value, which may be user-designated.

If such a difference is not below the threshold value, then, in step 311, noise fingerprint matching module 119 determines whether the parameters of development quantum system 105 have been adjusted greater than a threshold number of times, which may be user-designated.

If the parameters of development quantum system 105 have been adjusted greater than a threshold number of times, then, in step 312, noise fingerprint matching module 119 outputs a notification to the developer (user of development quantum system 105) that the parameters of development quantum system 105 could not be adjusted in a manner that enabled the difference between the noise fingerprints of quantum systems 104, 105 to be below a threshold value thereby not ensuring that the quantum circuit or quantum model being developed on development quantum system 105 will perform in a similar manner when executed on production quantum system 104. Furthermore, in one embodiment, in such a scenario, the metadata pertaining to the adjustments that were able to be made to the parameters of development quantum system 105 are stored, such as in a data structure (e.g., table) that resides within the storage device (e.g., storage device 211, 215) or database 117 of RTE/service racks 108, and/or attached to models subsequently developed on development quantum system 105 in order to highlight and specify deviations to be expected when the models are executed on production quantum system 104.

If, however, the parameters of development quantum system 105 have not been adjusted greater than a threshold number of times, then adjustment module 115 makes further adjustments to the parameters of development quantum system 105 by requesting noise fingerprint matching module 119 to provide instructions as to such further adjustments in step 307.

In one embodiment, noise fingerprint matching module 119 performs the same analysis as discussed above in connection with FIG. 4 to provide an instruction to adjustment module 115 as to the further adjustments to be made to the parameters of development quantum system 105. For example, based on the operational and performance data of development quantum system 105 that are obtained from operational/performance data logging module 113 after adjustment of the parameters of development quantum system 105, noise fingerprint matching AI model 120 generates a noise fingerprint eigenvector for development quantum system 105 as discussed above. After analyzing the generated eigenvector for development quantum system 105 (after adjusting the parameters of development quantum system 105) along with the previously generated eigenvector for production quantum system 104, a difference vector between such eigenvectors is computed, which is used to identify a cluster in the self organized map that is associated with particular adjustments to be made to the parameters of development quantum system 105. Noise fingerprint matching module 119 then instructs adjustment module 115 to perform such further adjustments to the parameters of development quantum system 105 as discussed above.

An illustration of adjusting the parameters of development quantum system 105 over multiple iterations is provided in FIGS. 6A-6C.

FIGS. 6A-6C illustrate adjusting the parameters of development quantum system 105 over multiple iterations in accordance with an embodiment of the present disclosure.

Referring to FIG. 6A, FIG. 6A illustrates an initial state of the settings for the parameters of development quantum system 105 in which no adjustments to the parameters have yet been performed. As illustrated in FIGS. 6A-6C, examples of parameters of development quantum system 105 include pulse level, pulse amplification, pulse modulation, pulse signal mixing, radio frequency radiated frequency, radio frequency transmit power, fridge temperature, environment temperature, environment humidity, environment pressure, vibration frequency, and vibration amplitude.

FIG. 6B illustrates adjustments made to the parameters of development quantum system 105 after the first iteration, such as via internal noise generation devices 116 and/or external noise generation devices 111.

FIG. 6C illustrates further adjustments made to the parameters of development quantum system 105 after a second iteration, which was required since the difference between the noise fingerprint of development quantum system 105 (after adjustment of the parameters of development quantum system 105) and the noise fingerprint of production quantum system 104 was not below a threshold value. In one embodiment, such adjustments were made via internal noise generation devices 116 and/or external noise generation devices 111.

Returning to FIG. 3, in conjunction with FIGS. 1-2, 4-5 and 6A-6C, referring to step 310, if, however, the difference between the noise fingerprint of development quantum system 105 after adjustment of the parameters of development quantum system 105 and the noise fingerprint of production quantum system 104 is below a threshold value, then, in step 313, noise fingerprint matching module 119 updates the cluster model with unsupervised learning based on the final adjustment to the parameters of development quantum system 105.

In step 314, noise fingerprint matching module 119 outputs a notification to the developer (e.g., user of development quantum system 105) regarding the adjustments to the parameters of development quantum system 105. Development quantum system 105 is now ready to be used for the developer to develop a quantum circuit or a quantum model which will perform in a similar manner when executed on production quantum system 104.

By matching the noise fingerprint of development quantum system 105 to the noise fingerprint of production quantum system 104, there is a higher confidence level that performance of any quantum circuit or quantum model developed on development quantum system 105 will have similar performance when run on production quantum system 104.

In this manner, the quantum circuit and the quantum model developed on a developer's quantum system will perform in a similar manner when executed on a different quantum system, such as the production quantum system.

Furthermore, the principles of the present disclosure improve the technology or technical field involving quantum computing.

As discussed above, as the number of quantum devices and quantum data centers grows around the world, it is becoming more and more important to ensure compatibility and interoperability between the quantum hardware in different locations. Furthermore, it is important to ensure that the quantum circuits and quantum models that are developed on one quantum system (includes a quantum computer), such as the developer's quantum system, perform in a similar and predictable manner when executed on another quantum system. Due to the fact that different environments may be subject to different sources of noise, the quantum circuits and quantum models that are developed on one quantum system, such as the developer's quantum system, may not perform in a similar manner when executed on another quantum system, even if such quantum systems are compatible in terms of quantum hardware. For example, it is common practice for developers to create quantum models and quantum circuits to meet the needs of their clients. However, due to the sensitivity of quantum systems, the performance of such quantum models and quantum circuits on the developer's quantum system can be different than the performance of the same quantum models and quantum circuits running on the client's quantum system that has a different noise fingerprint. A noise fingerprint refers to the main features of the quantum noise sources affecting a quantum device, such as a quantum system. For instance, various sources can contribute to noise, such as temperature, humidity, vibration, location radiation (e.g., wireless communication frequencies), solar flares, etc. In another example, a quantum computer installed at one location (e.g., cafeteria) may experience different natural noise in comparison to another quantum computer installed at a different location (e.g., data center). Unfortunately, there is not currently a means in ensuring that the quantum model and the quantum circuit developed on a developer's quantum system will perform in a similar manner when executed on a different quantum system, such as the client's quantum system (also referred to as the “production quantum system”).

Embodiments of the present disclosure improve such technology by obtaining operational and performance data from the development quantum system and the production quantum system. Examples of such data can include, but are not limited to, historical and/or current calibration data, system settings, a quantum processor temperature, pulse settings, qubit coherence times, qubit errors, qubit and quantum gate fidelity, gate errors, T1 (thermal relation time) and T2 (dephasing time) times, performance history of quantum circuits, noise types, noise strength, etc. A noise fingerprint for the development quantum system and a noise fingerprint for the production quantum system are generated based on the obtained operational and performance data. A noise fingerprint, as used herein, refers to the main features of the quantum noise sources affecting a quantum device, such as a quantum system. In one embodiment, such noise fingerprints may correspond to eigenvectors which are generated based on the obtained operational and performance data. An eigenvector, as used herein, refers to a vector which, when operated on by a given operator, gives a scalar multiple of itself. Parameters of the development quantum system may then be continually adjusted until the difference between the noise fingerprint for the development quantum system and the noise fingerprint for the production quantum system is below a threshold value, which may be user-designated. Examples of such parameters to be adjusted on the development quantum system can include, but are not limited to, pulse amplification, pulse attenuation, pulse modulation, pulse signal mixing, radio frequency radiated frequency, radio frequency transmit power, temperature setting of a quantum refrigerator, environmental temperature, environmental humidity, environmental pressure, vibration frequency, vibration amplitude, etc. In this manner, the quantum circuit and the quantum model developed on a developer's quantum system will perform in a similar manner when executed on a different quantum system, such as the production quantum system. Furthermore, in this manner, there is an improvement in the technical field involving quantum computing.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for optimizing development of a quantum circuit or a quantum model on a first quantum system for later use on a second quantum system, the method comprising:
obtaining operational and performance data from said first and second quantum systems;
generating a first noise fingerprint for said first quantum system and a second noise fingerprint for said second quantum system based on said obtained operational and performance data from said first and second quantum systems, respectively; and
adjusting parameters of said first quantum system until a difference between said first noise fingerprint of said first quantum system and said second noise fingerprint of said second quantum system is below a threshold value.

2. The method as recited in claim 1, wherein said operational and performance data comprises one or more of the following selected from the group consisting of: historical calibration data, current calibration data, system settings, a quantum processor temperature, pulse settings, qubit coherence times, qubit errors, qubit and quantum gate fidelity, gate errors, thermal relation times, dephasing times, performance history of quantum circuits, noise types, and noise strengths.

3. The method as recited in claim 1, wherein said first and second noise fingerprints are represented by eigenvectors that are created based on said operational and performance data of said first and second quantum systems, respectively.

4. The method as recited in claim 1 further comprising:
determining compatibility between said first and second quantum systems based on said operational and performance data from said first and second quantum systems, wherein said first quantum system is compatible with said second quantum system in response to at least a portion of a coupling map of said first quantum system being within a threshold degree of similarity to at least a portion of a coupling map of said second quantum system or in response to a qubit coherence time and a gate fidelity on matching portions of coupling maps of said first and second quantum systems being the same or better on said first quantum system than said second quantum system.

5. The method as recited in claim 1, wherein said parameters comprise one or more of the following selected from the group consisting of: pulse amplification, pulse attenuation, pulse modulation, pulse signal mixing, radio frequency radiated frequency, radio frequency transmit power, temperature setting of a quantum refrigerator, environmental temperature, environmental humidity, environmental pressure, vibration frequency, and vibration amplitude.

6. The method as recited in claim 1, wherein said parameters of said first quantum system are adjusted to increase noise on said first quantum system.

7. The method as recited in claim 1, wherein an artificial intelligence model is used to compare said first noise fingerprint of said first quantum system with said second noise fingerprint of said second quantum system to output one or more parameter adjustments of said first quantum system.

8. The method as recited in claim 1 further comprising:
attaching metadata pertaining to adjustments of said parameters of said first quantum storage to models subsequently developed on said first quantum system to specify deviations to be expected when said models are executed on said second quantum system in response to said difference between said first noise fingerprint of said first quantum system and said second noise fingerprint of said second quantum system not being below said threshold value.

9. A computer program product for optimizing development of a quantum circuit or a quantum model on a first quantum system for later use on a second quantum system, the computer program product comprising one or more computer readable storage mediums having program code embodied therewith, the program code comprising programming instructions for:
obtaining operational and performance data from said first and second quantum systems;
generating a first noise fingerprint for said first quantum system and a second noise fingerprint for said second quantum system based on said obtained operational and performance data from said first and second quantum systems, respectively; and
adjusting parameters of said first quantum system until a difference between said first noise fingerprint of said first quantum system and said second noise fingerprint of said second quantum system is below a threshold value.

10. The computer program product as recited in claim 9, wherein said operational and performance data comprises one or more of the following selected from the group consisting of: historical calibration data, current calibration data, system settings, a quantum processor temperature, pulse settings, qubit coherence times, qubit errors, qubit and quantum gate fidelity, gate errors, thermal relation times, dephasing times, performance history of quantum circuits, noise types, and noise strengths.

11. The computer program product as recited in claim 9, wherein said first and second noise fingerprints are represented by eigenvectors that are created based on said operational and performance data of said first and second quantum systems, respectively.

12. The computer program product as recited in claim 9, wherein the program code further comprises the programming instructions for:
determining compatibility between said first and second quantum systems based on said operational and performance data from said first and second quantum systems, wherein said first quantum system is compatible with said second quantum system in response to at least a portion of a coupling map of said first quantum system being within a threshold degree of similarity to at least a portion of a coupling map of said second quantum system or in response to a qubit coherence time and a gate fidelity on matching portions of coupling maps of said first and second quantum systems being the same or better on said first quantum system than said second quantum system.

13. The computer program product as recited in claim 9, wherein said parameters comprise one or more of the following selected from the group consisting of: pulse amplification, pulse attenuation, pulse modulation, pulse signal mixing, radio frequency radiated frequency, radio frequency transmit power, temperature setting of a quantum refrigerator, environmental temperature, environmental humidity, environmental pressure, vibration frequency, and vibration amplitude.

14. The computer program product as recited in claim 9, wherein said parameters of said first quantum system are adjusted to increase noise on said first quantum system.

15. The computer program product as recited in claim 9, wherein an artificial intelligence model is used to compare said first noise fingerprint of said first quantum system with said second noise fingerprint of said second quantum system to output one or more parameter adjustments of said first quantum system.

16. The computer program product as recited in claim 9, wherein the program code further comprises the programming instructions for:
attaching metadata pertaining to adjustments of said parameters of said first quantum storage to models subsequently developed on said first quantum system to specify deviations to be expected when said models are executed on said second quantum system in response to said difference between said first noise fingerprint of said first quantum system and said second noise fingerprint of said second quantum system not being below said threshold value.

17. A system, comprising:
a memory for storing a computer program for optimizing development of a quantum circuit or a quantum model on a first quantum system for later use on a second quantum system; and
a processor connected to said memory, wherein said processor is configured to execute program instructions of the computer program comprising:
obtaining operational and performance data from said first and second quantum systems;
generating a first noise fingerprint for said first quantum system and a second noise fingerprint for said second quantum system based on said obtained operational and performance data from said first and second quantum systems, respectively; and
adjusting parameters of said first quantum system until a difference between said first noise fingerprint of said first quantum system and said second noise fingerprint of said second quantum system is below a threshold value.

18. The system as recited in claim 17, wherein said operational and performance data comprises one or more of the following selected from the group consisting of: historical calibration data, current calibration data, system settings, a quantum processor temperature, pulse settings, qubit coherence times, qubit errors, qubit and quantum gate fidelity, gate errors, thermal relation times, dephasing times, performance history of quantum circuits, noise types, and noise strengths.

19. The system as recited in claim 17, wherein said first and second noise fingerprints are represented by eigenvectors that are created based on said operational and performance data of said first and second quantum systems, respectively.

20. The system as recited in claim 17, wherein the program instructions of the computer program further comprise:
determining compatibility between said first and second quantum systems based on said operational and performance data from said first and second quantum systems, wherein said first quantum system is compatible with said second quantum system in response to at least a portion of a coupling map of said first quantum system being within a threshold degree of similarity to at least a portion of a coupling map of said second quantum system or in response to a qubit coherence time and a gate fidelity on matching portions of coupling maps of said first and second quantum systems being the same or better on said first quantum system than said second quantum system.
